(19) United States
(12) Patent Application Publication
(10) Pub. No.: US 2025/0335677 A1
(43) Pub. Date: Oct. 30, 2025

(54) SYSTEMS, METHODS, AND COMPUTER READABLE MEDIA FOR BEHAVIORAL MODELLING OF CIRCUITS

(71) Applicant: Keysight Techynologies, Inc., Santa Rosa, CA (US)

(72) Inventors: Jan Maria Petrus Verspecht, Santa Rosa, CA (US); Jianjun Xu, Santa Rosa, CA (US)

(21) Appl. No.: 18/649,359

(22) Filed: Apr. 29, 2024

(51) Int. Cl. G06F 30/3308; G06F 119/06

(52) U.S. Cl. CPC G06F 30/3308; G06F 2119/06

(57) ABSTRACT

Methods, systems, and computer readable media for behavioral modelling of circuits. An example method includes extracting a model from a plurality of measurements of a power amplifier. The method includes performing simulation of a circuit including the power amplifier under one or more modulated operating conditions. Performing the simulation includes modelling one or more memory effects of the power amplifier and modelling one or more mismatch conditions of the power amplifier under the modulated operating conditions.

### TECHNICAL FIELD

The subject matter described herein relates to methods, systems, and computer readable media for behavioral modelling of circuits and in particular to adding load-pull capability to models.

### BACKGROUND

Computer aided design (CAD) of an active phased array antenna requires the fast and accurate simulation of a circuit containing many power amplifiers. To be accurate, these simulations stimulate memory effects that will be present in the application. This is typically achieved by using an envelope simulator and using a modulated stimulus signal. The envelope simulation of a circuit containing many amplifiers is challenging. Firstly, it can take a very long time to run a simulation when detailed circuit schematics are being used for each of the power amplifiers. Secondly, a circuit schematic of the power amplifier may not be available.

Accordingly, a need exists for methods, systems, and computer readable media for behavioral modelling of circuits that can be used for, e.g., designing active phased array antennas.

### SUMMARY

Methods, systems, and computer readable media for behavioral modelling of circuits. An example method includes extracting a model from a plurality of measurements of a power amplifier. The method includes performing simulation of a circuit including the power amplifier under one or more modulated operating conditions. Performing the simulation includes modelling one or more memory effects of the power amplifier and modelling one or more mismatch conditions of the power amplifier under the modulated operating conditions.

The subject matter described herein may be implemented in software in combination with hardware and/or firmware. For example, the subject matter described herein may be implemented in software executed by a processor. In one example implementation, the subject matter described herein may be implemented using a non-transitory computer readable medium having stored therein computer executable instructions that when executed by the processor of a computer control the computer to perform steps. Example computer readable media suitable for implementing the subject matter described herein include non-transitory devices, such as disk memory devices, chip memory devices, programmable logic devices, field-programmable gate arrays, and application specific integrated circuits. In addition, a computer readable medium that implements the subject matter described herein may be located on a single device or computer platform or may be distributed across multiple devices or computer platforms.

### BRIEF DESCRIPTION OF THE DRAWINGS

The subject matter described herein will now be explained with reference to the accompanying drawings of which:

FIG. 1 is a block diagram of an example system for computer aided design (CAD) of circuits such as phased antenna arrays having power amplifiers;

FIG. 2 is a block diagram illustrating an example behavioral modelling approach using a cascade of blocks;

FIG. 3 is a block diagram illustrating an artificial neural network;

FIG. 4 is a screen shot of an example screen from a graphical user interface of an automated circuit design tool;

FIG. 5 is a block diagram of an example method for designing a circuit using an automated design tool.

### DETAILED DESCRIPTION

The output load of the amplifiers in an active antenna array depends on the steering angle, and behavioral models often do not include this dependency. One exception are X-parameters, but this behavioral modelling approach does not include memory effects and, as such, the model loses accuracy as the modulation bandwidth increases. This document describes methods, systems, and computer readable media to add load-pull capability to existing behavioral models, for example, the Dynamic Gain or Memory Polynomial model.

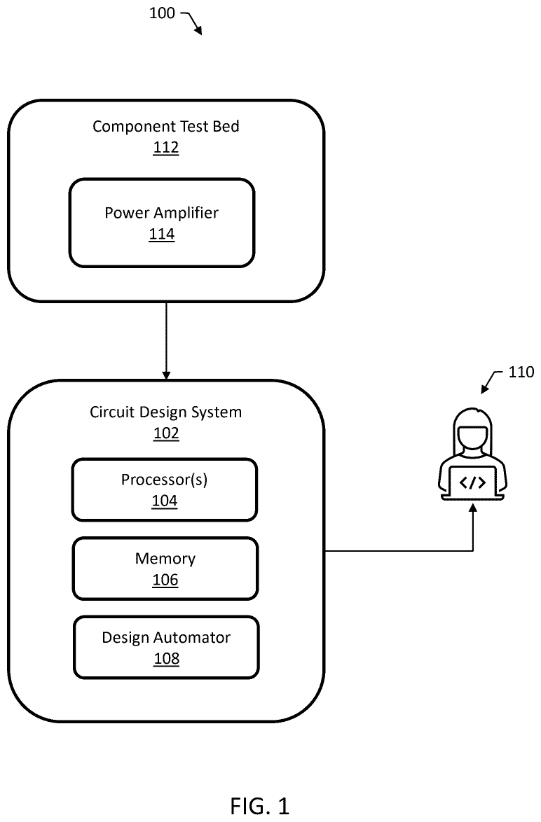

FIG. 1 is a block diagram of an example system 100 for computer aided design (CAD) of circuits such as phased antenna arrays having power amplifiers. The system 100 includes a circuit design system 102 having one or more processors 104, memory 106 storing instructions for the processors 104, and a design automator 108 implemented on the processors 104. A circuit designer 110 or other appropriate person can use the circuit design system 102, e.g., through a display and a user interface.

The system 100 includes a component test bed 112 configured to take measurements of a power amplifier 114. The component test bed 112 can include any appropriate testing hardware for characterizing the power amplifier 114 for behavioral modelling. Typically, the component test bed 112 applies various signals to the power amplifier 114 and measures the output of the power amplifier 114.

In some examples, the component test bed 112 includes a vector signal generator (VSG) as the signal source. The VSG can provide a well-defined stimulus signal, typically a continuous wave (CW) or a modulated carrier, with adjustable power level, frequency, and modulation parameters. A directional coupler can split the VSG output into two paths. One path would directly connect to the input of the power amplifier 114. The other path would serve as the reference for power measurements.

In some examples, a variable attenuator placed before the power amplifier 114 allows for precise control of the input power level. A bias network can provide the necessary DC voltages and currents to set the power amplifier 114 in the desired operating point. The output of the power amplifier 114 can be connected through, e.g., a low-pass filter to dampen any unwanted harmonics. The filtered output signal would then be fed to a power sensor for measurement. The reference path signal can, in some cases, be attenuated and filtered before reaching a second power sensor for a differential power measurement.

In operation, the circuit designer 110 specifies the design of a circuit including one or more instances of the power amplifier 114, and the design automator 108 performs a simulation of the circuit under one or more modulated operating conditions. Performing the simulation includes modeling one or more memory effects of the power amplifier 114 and modeling one or more mismatch conditions of the power amplifier 114 under the modulated operating conditions.

The circuit being designed can be a phased array antenna, and the modulated operating conditions can include a changing beam angle of the phased array antenna. Modelling one or more memory effects of the power amplifier can include modelling at least one time-varying transfer characteristic of a relationship between an input to the power amplifier and an output of the power amplifier based on a recent signal history. Modelling one or more mismatch conditions can include modelling a situation where an impedance of an output of the power amplifier does not match an impedance of an input of the phased array antenna.

In some examples, performing the simulation of the circuit (and one or more instances of the power amplifier 114) includes modelling a cascade of blocks. Modelling the cascade of blocks can include modelling a behavioral model into 50 Ohms. Modelling the cascade of blocks can include modelling a load dependent X-parameter block.

Modelling the X-parameter block can include using a matched output as a reference. Modelling the X-parameter block can include using a neural network to identify the X-parameter block. Modelling the X-parameter block can include implementing the X-parameter block using frequency division duplexing (FDD).

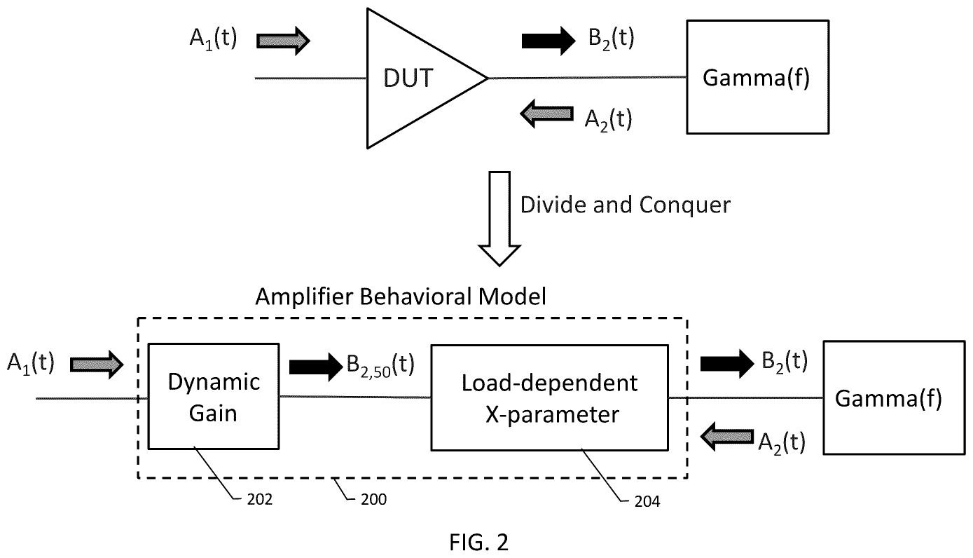

FIG. 2 is a block diagram illustrating an example behavioral modelling approach using a cascade of blocks 200. The cascade of blocks 200 for the amplifier behavioral model can include, for example, a dynamic gain block 202 and a load-dependent X-parameter block 204.

The modelling approach assumes that all the nonlinear memory effects are in the amplification process of the incident complex envelope signal A₁(t), and that the interaction between the reflected A₂(t) and the amplifier output is nonlinear but static. These assumptions enable a solution that is based on using the formalism of the load-dependent X-parameters. The model equation is as follows.

$${B}_{2} ( t ) = {X}_{F} ( \vert {B}_{2 , 50} ( t ) \vert , Re ( {A}_{2} ( t ) {P ( t )}^{- 1} ) , Im ( {A}_{2} ( t ) {P ( t )}^{- 1} ) ) P ( t ) \qquad ( 1 )$$

$$P ( t ) = exp ( j φ ( {B}_{2 , 50} ( t ) ) ) \qquad ( 2 )$$

$${B}_{2 , 50} ( t ) = \hat{M} [ {A}_{1} ( t ) ] \qquad ( 3 )$$

with B₂(t) the complex envelope representation of the pseudo-wave representing the response signal, A₂(t) the complex envelope representation of the pseudo-wave representing the incident signal at the output of the amplifier, and with B_{2,50} (t) representing the output signal into a perfectly matched condition. The relationship between B_{2,50} (t) and A₁(t) is described by the functional \hat{M}[·].

This functional \hat{M}[·] can be described by any behavioral modelling technique, such as a Dynamic Gain model.

Note that the main difference with the X-parameter formulation is that the formulation uses B_{2,50} (t) as the reference signal, rather than A₁(t). This provides an elegant way to divide and conquer the behavioral model identification as we can treat the determination of the function X_{F} (. , . , . ) and the functional \hat{M}[·] as completely independent problems. \hat{M}[·] captures the nonlinear memory effects of the amplification process, and X_{F} (. , . , . ) captures the nonlinear, yet static, interaction with the arbitrary load.

The functional \hat{M}[·] can be identified by any appropriate method. The function X_{F} (. , . , . ) is defined on the 3-dimensional input space formed by the real variables |B_{2,50}(t)|, Re(A₂(t)P(t)⁻¹), and Im(A₂(t)P(t)⁻¹). Any experiments with the goal of identifying the function will need to cover this 3-dimensional space. Since B_{2,50} (t) typically corresponds to the response of the amplifier to a pseudo-random modulated signal with both amplitude and phase modulation, the quantity |B_{2,50}(t)|will cover a range of amplitudes from close to zero to a peak value, B_{2,MAX}, and P(t) will completely cover the unit circle.

If the function is extracted in a simulated experiment, we can easily generate any arbitrary A₂(t), and there are plenty of possibilities to create an experiment that sufficiently covers the input space. If we perform a measurement-based extraction, such an experiment can be performed by using 2 vector signal generators, one for generating A₁(t) and one for generating A₂(t). A simpler and less costly approach exists whereby one generates a set of continuous-wave (CW) signals for A₂(t).

Such a measurement requires only one vector signal generator (for generating A₁(t)) and one CW synthesizer (for generating A₂(t)). One CW stimulus signal corresponds to sampling the X_{F} (. , . , . ) function on a cylinder, whereby B_{2,MAX} represents the height of the cylinder, and the constant amplitude of the CW A₂(t) represents the radius of the cylinder. The complete input space can be sampled by repeating this experiment for a range of amplitude values, which would typically range from 0 to B_{2,MAX}. Note that the measured B₂(t) with applying an amplitude equal to zero for A₂(t) corresponds to the measured value for B_{2,50}(t).

Once all the data samples are acquired, a multidimensional curve fit is performed, and the fitted function X_{Ffit} (. , . , . ) can be used as the behavioral model to represent the amplifier load-pull behavior in a simulator. A neural network can be used as the multidimensional curve fitter.

A particular issue that arises with the measurement-based model extraction is phase alignment. Each time the network analyzer acquires the phases of all measured spectra, there is one arbitrary phase offset and phase slope that is present for all the measured waves. This is caused by the arbitrary phase of the local oscillator of the VNA receivers, and by the arbitrary delay in the ADC data acquisition. This arbitrary phase slope and offset is common for all measured waves. This arbitrary phase offset and phase slope causes an issue with the model extraction as the extraction depends on measuring P(t).

Consider that we first perform a measurement of B_{2,50}(t). This is done by not injecting any A₂(t), or equivalently A₂(t)=0. We also measure the corresponding A₁(t), which we call A_{1,50}(t).

Next, we apply several A₂(t) signals that are different from zero (CW or modulated) and we measure the corresponding waveforms A_{1,i}(t), A_{2,}i(t), and B_{2,i}(t), with subscript “i” referring to the experiment with index “i”. In the following we will use index 0 to refer to the measurement whereby A₂(t)=0. We refer to the measured versions of these waveforms as A₁(t), A₂(t), and B₂(t). Each experiment has its own arbitrary delay τᵢ and arbitrary phase offset θᵢ, whereby we define the reference measurement the one with index “0”. This implies that θᵢ=0 and τᵢ=0.

The measured waves are then expressed by the following equations:

$${A}_{M 1 , i} ( t ) = {A}_{1 , i} ( t - {τ}_{i} ) {e}^{j {θ}_{i}} \qquad ( 4 )$$

$${A}_{M 2 , i} ( t ) = {B}_{2 , i} ( t - {τ}_{i} ) {e}^{j {θ}_{i}} \qquad ( 5 )$$

$${A}_{M 2 , i} ( t ) = {A}_{2 , i} ( t - {τ}_{i} ) {e}^{j {θ}_{i}} \qquad ( 6 )$$

It is assumed in the following that the amplifier has perfect isolation, or that the vector signal generator has a perfect match, such that:

$${A}_{1 , i} ( t ) = {A}_{1} ( t ) . \qquad ( 7 )$$

In other words, changing the load conditions on the output of the amplifier does not change the the input signal A₁(t). The model extraction is based on fitting the function X_{F} (. , . , . ) and requires the determination of Pᵢ(t) with

$${P}_{i} ( t ) = {B}_{2 , 50 , i} ( t ) . \qquad ( 8 )$$

The problem is that B_{2,50,i}(t) is not a true measurable quantity, but rather a virtual one as it refers to the B₂(t) one would measure if A_{2,i}(t) would be equal to zero (but it is not). Conceptually one can write, however,

$${B}_{2 , 50 , i} ( t ) = {B}_{2 , 50} ( t - {τ}_{i} ) {e}^{j {θ}_{i}} \qquad ( 9 )$$

We conclude that B_{2,50,i}(t) can be determined indirectly by applying (9) once we know τᵢ and θᵢ.

Both τᵢ and θᵢ are determined by aligning A_{M1,i}(t) with A_{M1,0}(t). This alignment can be achieved by using any appropriate algorithm. Consider, for example, the following algorithm.

First, do not apply an A₂(t) signal and measure B_{2,50}(t) and A_{1,50}(t). Next, apply different A₂(t) signals and measure A_{M1,i}(t), A_{M2,i} (t), and B_{M2,i} (. For each experiment, with index “i”, determine ci and θᵢ by aligning A_{M1,i}(t) with A_{M2,i} (t). Next, calculate the time aligned and phase compensated quantities B_{2,50,i} (t), which are given by (9). Finally, use the quantities B_{2,50,i} (t), A_{M2,i} (t), and B_{M2,i} (t to fit the function X_{F} (. , . , . ).

The Enhanced Poly Harmonic Distortion (EPHD) model, which can be considered as an extension of a load-dependent X-parameter model, has at least four major differences with the model described in this document. These differences can cause inaccuracies for practical applications, which are solved with the models described in this document.

A first difference is that the model is extracted based on the use of a set of CW excitations for the input signal A₁. Such a CW excitation fails to properly stimulate any nonlinear memory that is present in the amplifier, like for example self-heating, self-biasing or trapping effects. Such nonlinear memory effects can play a significant role in how the amplifier responds to load-pull conditions.

A second difference is that the model is expressed as a static function of the input signals A₁(t) and A₂(t), rather than as a static function of B_{2,50}(t) and A₂(t), as we do with our innovative approach. This has major consequences as none of the memory effects that are typically present in the amplification process are captured by the EPHD approach, whereas these are captured by using B_{2,50}(t) as the reference waveform, as we do with the new method.

A third difference is that the model is developed as a polynomial in A₂(t). Such a polynomial model typically has difficulties describing hard nonlinear behavior which occurs when the amplifier is saturating.

A fourth difference is the extrapolation capability versus power. It is expected that the EPHD model will extrapolate poorly if the instantaneous amplitude of A₁(t) at the input of the amplifier exceeds the maximum amplitude level of A₁(t) that was used during the model extraction.

With the methods and systems described in this document, we do not have this problem as the input to the function is not A₁(t), but B_{2,50}(t). Because of the saturation effect, the amplitude of B_{2,50}(t) is limited and the model, if characterized under saturated operating conditions, will not need to be evaluated with an amplitude of B_{2,50}(t) that is significantly higher than what was experienced by the model while being extracted.

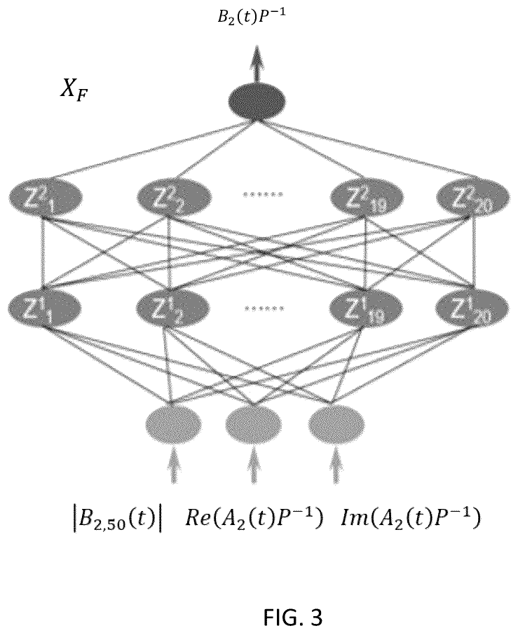

FIG. 3 is a block diagram illustrating an artificial neural network being used to extract X_{F}. In some cases, a generic ANN library can be used to generate a formula to represent discrete data.

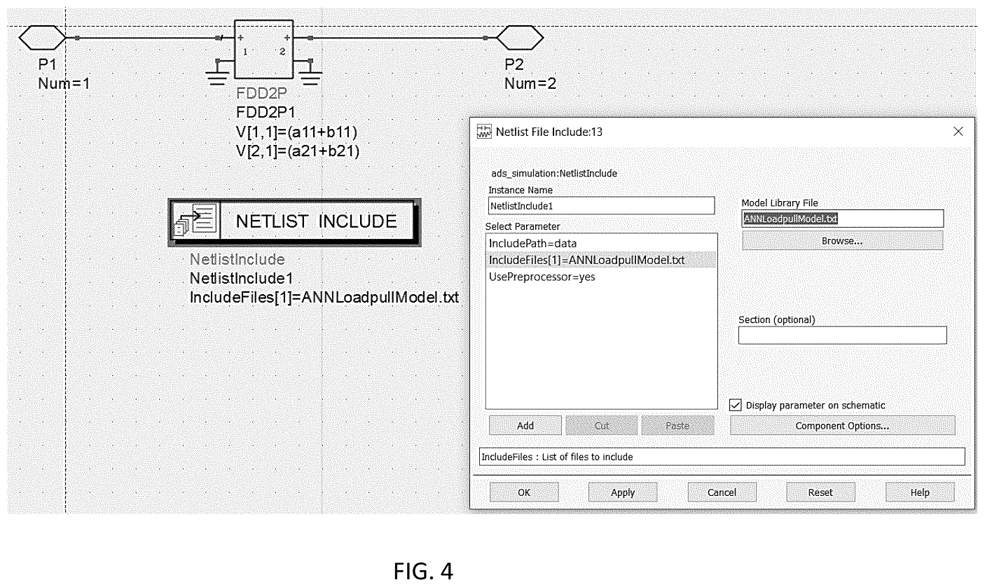

FIG. 4 is a screen shot of an example screen from a graphical user interface of an automated circuit design tool. The example screen shows a circuit schematic for a circuit being designed with a power amplifier. The behavior model is configured using a graphical user interface element (a window with text boxes) so that a simulation of the circuit can use the behavioral model of the power amplifier as described above.

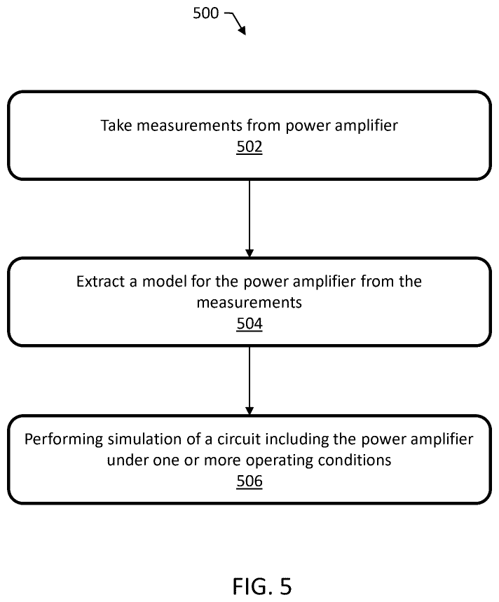

FIG. 5 is a block diagram of an example method 500 for designing a circuit using an automated design tool.

The method 500 includes taking measurements from a physical instance of a power amplifier, for example, in a test bed (502). The method 500 includes extracting a model for the power amplifier from the measurements (504). The method 500 includes performing simulation of the circuit including one or more simulated instances of the power amplifier under one or more operating conditions (506).

The circuit can be, for example, a phased array antenna, and the one or more modulated operating conditions can include a changing beam angle of the phased array antenna. Modelling one or more memory effects of the power amplifier can include modelling at least one time-varying transfer characteristic of a relationship between an input to the power amplifier and an output of the power amplifier based on a recent signal history. Modelling one or more mismatch conditions can include modelling a situation where an impedance of an output of the power amplifier does not match an impedance of an input of the phased array antenna.

In some examples, performing the simulation of the circuit (and one or more instances of the power amplifier) includes modelling a cascade of blocks. Modelling the cascade of blocks can include modelling a behavioral model into 50 Ohms. Modelling the cascade of blocks can include modelling a load dependent X-parameter block.

Modelling the X-parameter block can include using a matched output as a reference. Modelling the X-parameter block can include using a neural network to identify the X-parameter block. Modelling the X-parameter block can include implementing the X-parameter block using frequency division duplexing (FDD).

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method comprising:
extracting a model from a plurality of measurements of a power amplifier;
performing simulation of a circuit including the power amplifier under one or more modulated operating conditions, wherein performing the simulation includes:
modelling one or more memory effects of the power amplifier; and
modelling one or more mismatch conditions of the power amplifier under the modulated operating conditions.

2. The method of claim 1, wherein the circuit comprises a phased array antenna, and wherein the one or more modulated operating conditions includes a changing beam angle of the phased array antenna.

3. The method of claim 1, where modelling one or more memory effects of the power amplifier includes modelling at least one time-varying transfer characteristic of a relationship between an input to the power amplifier and an output of the power amplifier based on a recent signal history.

4. The method of claim 1, wherein modelling one or more mismatch conditions comprises modelling a situation where an impedance of an output of the power amplifier does not match an impedance of an input of the phased array antenna.

5. The method of claim 1, wherein performing the simulation of the circuit comprises modelling a cascade of blocks.

6. The method of claim 5, wherein modelling a cascade of blocks comprises modelling a behavioral model into 50 Ohms.

7. The method of claim 5, wherein modelling a cascade of blocks comprises modelling a load dependent X-parameter block.

8. The method of claim 7, wherein modelling the load dependent X-parameter block comprises using a matched output as a reference.

9. The method of claim 7, wherein modelling the load dependent X-parameter block comprises using a neural network to identify the X-parameter block.

10. The method of claim 7, wherein modelling the load dependent X-parameter block comprises implementing the X-parameter block using frequency division duplexing (FDD).

11. A system comprising:
one or more processors and memory storing instructions for the one or more processors;
a circuit design automator implemented on the one or more processers, the circuit design automator configured for:
receiving a model extracted from a plurality of measurements of a power amplifier;
performing simulation of a circuit including the power amplifier under one or more modulated operating conditions, wherein performing the simulation includes:
modelling one or more memory effects of the power amplifier; and
modelling one or more mismatch conditions of the power amplifier under the modulated operating conditions.

12. The system of claim 11, wherein the circuit comprises a phased array antenna, and wherein the one or more modulated operating conditions includes a changing beam angle of the phased array antenna.

13. The system of claim 11, wherein modelling one or more memory effects of the power amplifier includes modelling at least one time-varying transfer characteristic of a relationship between an input to the power amplifier and an output of the power amplifier based on a recent signal history.

14. The system of claim 11, wherein modelling one or more mismatch conditions comprises modelling a situation where an impedance of an output of the power amplifier does not match an impedance of an input of the phased array antenna.

15. The system of claim 11, wherein performing the simulation of the circuit comprises modelling a cascade of blocks.

16. The system of claim 15, wherein modelling a cascade of blocks comprises modelling a behavioral model into 50 Ohms.

17. The system of claim 15, wherein modelling a cascade of blocks comprises modelling a load dependent X-parameter block.

18. The system of claim 17, wherein modelling the load dependent X-parameter block comprises using a matched output as a reference.

19. The system of claim 17, wherein modelling the load dependent X-parameter block comprises using a neural network to identify the X-parameter block.

20. The system of claim 17, wherein modelling the load dependent X-parameter block comprises implementing the X-parameter block using frequency division duplexing (FDD).
